(19) United States
(12) Patent Application Publication
(10) Pub. No.: US 2026/0260369 A1
(43) Pub. Date: Sep. 3, 2026

(54) METHOD AND DEVICE FOR DETERMINING DEPTH INFORMATION ON A SCENE WITH IMAGES OF SAID SCENE TAKEN BY AT LEAST TWO CAMERAS

(71) Applicant: FOGALE OPTIQUE, MONTPELLIER (FR)

(72) Inventors: Eric LEGROS, MONTPELLIER (FR); Sylvain PETITGRAND, CAISSARGUES (FR); Bruno LUONG, NÎMES (FR)

(21) Appl. No.: 19/165,364

(22) PCT Filed: Mar. 21, 2023
(86) PCT No.: PCT/FR2023/050396

§ 371 Date: Sep. 15, 2025

(51) Int. Cl. G06T 7/579; G06T 7/246; G06T 7/73

(52) U.S. Cl. CPC G06T 7/579; G06T 7/248; G06T 7/74; G06T 2207/30252

(57) ABSTRACT

A method for determining depth information on a scene in a first image of said scene is disclosed herein. The method includes, for a target point of the scene in the first image, a processing phase that includes the following steps: identifying the target point in a second image of the scene, and calculating a depth associated with the target point according to a position of the target point in each of the first and second images. Identifying the target point in the second image includes comparing a previously calculated speed of the target point in the first image with a previously calculated speed of at least one point in the second image. A computer program, a device, a system, and a vehicle implementing such a method are also disclosed herein.

The present invention relates to a method for determining depth information of a scene from at least two images of said scene taken by at least two cameras. It also relates to a device and a system implementing such a method. It further relates to the use of the depth information in various applications, such as driving a vehicle, identifying objects in a scene or tracking objects in said scene.

The field of the invention is the determination of depth information associated with one or more points of a scene from several images of said scene.

### PRIOR ART

The depth of a point of a scene in an image of said corresponds to the distance between said point of the scene and the observation point from which the scene image was acquired. This distance, or depth, information is important and useful in a variety of applications. For example, it can be used to assist the driving, or autonomous driving, of a vehicle based on the position of objects in its environment. It can also be used for object detection, or for tracking objects over time.

A solution exists for calculating this depth information from at least two images of a scene taken by cameras located at different capture positions. By identifying the position of a same point in the scene on said images, and knowing the positions of the cameras, it is then possible to calculate the depth of said point on each image of the scene by triangulation.

However, these solutions are computationally intensive and time-consuming and produce results whose accuracy is not always satisfactory, particularly when the composition of the imaged scene is complex.

One aim of the present invention is to overcome at least one of the drawbacks of the prior art.

Another aim of the invention is to offer a solution for determining depth information from images of a scene, which requires fewer computing resources and/or is less time-consuming and/or produces more accurate results.

### DISCLOSURE OF THE INVENTION

The invention proposes to achieve at least one of the aforementioned aims by a method for determining depth information of a scene in a first image of said scene captured by a first camera positioned at a first capture position, said method comprising, for a target point of said scene in said first image, a processing phase comprising the following steps:
identifying said target point in a second image captured by a second camera positioned at a second capture position different from said first position, and
calculating a depth associated with said target point based on a position of said target point in each of said first and second images;
   characterized in that the identification step comprises comparing a speed data of said target point in said first image with a speed data of at least one point in said second image, said speed data being previously calculated.

Thus, in a manner similar to the state of the art, the invention proposes to determine the depth associated with a target point of a scene using the positions of this target point in at least two images of said scene captured by cameras positioned at different capture positions.

However, and in a completely innovative way that differs from the state of the art, the invention proposes to use a speed data of said target point in the first image to identify it in the second image. In this way, identifying the target point on the second image requires fewer computing resources and is less time-consuming. In addition, the speed information associated with the target point helps to reduce, or even avoid, errors when identifying the target point on the second image, resulting in more accurate and reliable results.

In other words, for a scene point in an image, and in particular for an image pixel corresponding to said scene point, the speed data enriches the data associated with said point/pixel. In this way, more data is available to identify this point in the scene on different images of said scene captured from different capture positions.

In the present application, “image” means a digital image and in particular a digital raster image. Each point of the matrix corresponds to a pixel of the image and comprises one or more numerical values representing different components of the image for said pixel. For example, in the case of an RGB image, each pixel may comprise three values, each representing one of the RGB components of the digital image. Of course, each pixel may comprise other values representing other properties, such as brightness, hue, saturation and so on.

In the present application, a point of a scene corresponds to a pixel of an image of said scene. When the scene is imaged by two cameras positioned at different capture positions, preferentially spaced as far apart as possible, the same point in the scene can correspond to two pixels at different positions in each of the two images. Preferentially, the camera planes can be parallel and the central axes of the cameras may be common in order to limit calculations, although this is not essential.

In the following, UV is the reference frame associated with the image sensor. This reference frame is a two-dimensional reference frame defining a plane, and in particular the plane of the image sensor used for image acquisition.

In the following, XY is the reference frame associated with the scene. In addition, Z is the direction perpendicular to the image plane, that is to say the plane XY, in the reference frame of the scene.

For a point in an image, that is to say for the target point and/or for at least one point in the second image, the speed data used in the target point identification step comprises at least the speed of said point in the image plane.

The speed of a point in the image plane may be expressed in a reference frame, denoted UV, linked to the image sensor. In this case, the speed of said point in the image plane, denoted Vᵤᵥ, is a two-dimensional speed vector comprising a first value, denoted Vᵤ, giving the velocity in the direction U in the image plane, and a second value, denoted Vᵥ, giving the speed in the direction V in the image plane.

According to the invention, the first image may be captured at a first instant, called the first current instant, and the second image is captured at a second instant, called the second current instant.

The first current instant and the second current instant are identical, or different instants but very close in time, so that the displacement of scene points between said instants is negligible.

Without loss of generality, and to avoid cumbersome wording, it is considered hereinafter that the first current instant and the second current instant are identical and are referred to as the current instant.

The processing phase, or the method according to the invention, may comprise a step for calculating the speed of the target point in the first image.

Alternatively, the speed of the target point in the first image may be calculated in a preliminary step that is not part of the method according to the invention. For example, the first image may be an enhanced image that already comprises the speed associated with the target point. The speed data of the target point may be part of the data of the pixel corresponding to said target point in the first image.

For at least one point of the second image, the processing phase, or the method according to the invention, may comprise a step for calculating the speed of said point in said second image.

Alternatively, for at least one point of the second image, the speed of said point in the second image may be calculated in a preliminary step that is not part of the method according to the invention. For example, the second image may be an enhanced image that already comprises the speed associated with said point. For example, the speed data of this point can be part of the data of the pixel corresponding to said point in the second image.

According to the invention, the speed data associated with a point in an image may be calculated in any known way, and the invention is not limited to a specific way of calculating said speed data.

According to some embodiments, the speed data of a point of an image may be calculated from said image and from at least one image, called past image, captured by the same camera at a past instant preceding the current instant at which said image was captured.

For example, the speed of the target point in the first image may be calculated using an image captured by the first camera at a past instant preceding the current instant at which the first image is captured. The past image may or may not be the image immediately preceding the first image, for example in a stream of images captured by the first camera.

Alternatively, or in addition, the speed of a point in the second image may be calculated using an image captured by the second camera at a past instant preceding the current instant at which the second image is captured. The past image may or may not be the image immediately preceding the second image, for example in a stream of images captured by the first camera.

According to a non-limiting example, the step of calculating the speed data of a point in an image may comprise the following steps:
identifying said point in the past image;
calculating a distance separating the positions of said point in said image and in the past image; and
calculating a speed data based on said distance and the time separating the current and past instants.

For example, the speed of the target point in the first image may be calculated by dividing the distance separating the positions of said target point in the first image and in the past image, captured by the first camera, by the time separating the capture instants of the first image and the past image. This results in a two-dimensional speed vector giving the speed of the target point in the plane of the first image.

Alternatively, or in addition, for at least one point of the second image, the speed of said point may be calculated by dividing the distance separating the positions of said point in the second image and in the past image, captured by the second camera, by the time separating the capture instants of the second image and the past image. This results in a two-dimensional speed vector giving the speed of said point in the plane of the second image.

The identification, in a past image, of a point in a current image, may take into account speed data associated with points in said past image, when these speed data are known. In fact, by knowing the speeds of at least some of the points in the past image, it is possible to determine which of these points could potentially be in the current image at the location of said point. In this way, it is possible to determine a likely position of the point in the past image. The search for the point in the past image may begin at said likely position.

This solution may be used when determining the speed of the target point in the first image.

This solution may be used when determining the speed of a point in the second image.

In general, this solution may be used to identify a point in a current image captured by a camera in a past image captured by said camera at a past instant.

Additionally, during the step of calculating the speed of a point in a current image, the identification of said point in the current image in a past image can be achieved by comparing the pixel corresponding to this point in said current image with at least one pixel in said past image. The comparison may relate to at least one of the following respective data of said pixels:
color data,
texture data,
brightness data,
hue data,
saturation data,
RGB data,
property calculated from at least one of these data,
etc.

Optionally, the pixel's environment may also be taken into account during comparison, to boost confidence in the comparison, such as the pixel's membership in a similar geometric pattern (such as a line, of comparable direction) between the images, and/or a similar color pattern around the pixel.

According to some embodiments, the identification step of the target point in the second image may further comprise comparing an acceleration data associated with the target point in said first image with an acceleration data of at least one point in said second image, said acceleration data being previously calculated.

The processing phase, or the method according to the invention, may comprise a step for calculating the acceleration of the target point in the first image.

Alternatively, the acceleration of the target point in the first image may be calculated in a preliminary step that is not part of the method according to the invention. For example, the first image may be an enhanced image that already comprises the acceleration associated with the target point. The acceleration data of the target point can for example be part of the data of the pixel corresponding to said target point in the first image.

The processing phase, or the method according to the invention, may comprise, for at least one point of the second image, a step for calculating the acceleration of said point in said second image.

Alternatively, for at least one point of the second image, the acceleration of said point in the second image may be calculated in a preliminary step that is not part of the method according to the invention. For example, the second image may be an enhanced image that already comprises the acceleration associated with said point. For example, the acceleration data of this point can be part of the data of the pixel corresponding to said point in the second image.

For a point in a current image, the acceleration data may be determined by any known means.

According to some embodiments, for a point in a current image, the acceleration of the point in said current image may be determined based on:
a speed of said point in said current image;
a speed of said point in a past image captured by the same camera, at an instant in the past relative to the capture instant, referred to as the current instant, of said current image; and
an elapsed time between the current instant and the past instant

The speed of the point in the current image may be calculated as described above. The speed data of the point in the past image may be calculated in a similar way, using a so-called previous image captured by the same camera at a so-called previous instant preceding the past instant at which the past image was captured.

In other words, the acceleration of the target point in the first image may be calculated based on:
the speed of said target point in a past image captured by the first camera at a past instant preceding the current instant at which the first image is captured;
the speed of said target point in the first image; and
the time between said past and current instants.

Alternatively, or additionally, for at least one point in the second image, the acceleration of said point in the second image may be calculated based on:
the speed of said point in a past image captured by the second camera at a past instant preceding the current instant at which the second image is captured;
the speed of said point in the second image; and
the time between said past and current instants.

As mentioned above, according to the invention, the target point is identified in the second image by comparing the speed data, and optionally the acceleration data, of said target point in the first image with a speed data, and possibly acceleration data, of one or more points of the scene in the second image.

According to some embodiments, the step of identifying the target point in the second image may further comprise a comparison of the pixel corresponding to said target point in the first image with at least one pixel in the second image, said comparison relating to at least one of the following data:
color data,
texture data,
brightness data,
hue data,
saturation data,
RGB data,
a data deduced from these data,
etc.

Furthermore, optionally, the target point's environment may also be taken into account during comparison, to boost confidence in the comparison, such as the target point's membership in a similar geometric pattern (such as a line, of comparable direction) between the images, and/or a similar color pattern around the target point.

Thus, when the target point is compared with a point in the second image, this comparison is based on the respective data:
speed,
and optionally acceleration and/or any combination of the data listed above. In this way, the target point on the second image can be identified more accurately.

According to some embodiments, the search for the target point in the second image may begin at an arbitrary position in the second image.

Alternatively, the search for the target point in the second image may begin at the position this target point has in the first image.

According to other embodiments, the processing phase may comprise a selection of a target area wherein said target point may be located in the second image, said selection being made based on:
a speed in the image plane, associated with said target point at an instant preceding the current instant, for example in a past image taken by the first camera or in a past image taken by the second camera; and
a position of said target point in the first image, and/or in an image captured by the first camera at an instant preceding the current instant and/or in an image captured by the second camera at an instant preceding the current instant
   In this case, the search for the target point in the second image may begin with said area of interest.

Indeed, knowing the position of the target point in the first image, it is possible to find it in a past image taken by the first camera, at a past instant. It is possible that the target point has been identified on a past image taken by the second camera at said past instant, for example during a previous iteration of the method according to the invention. It is further possible that the speed of the target point has been determined in the past image taken by the first camera, or in the past image taken by the second camera, for example during a previous iteration of the method according to the invention. Each of these data can be used, alone or in combination with another of said data, to estimate a likely position of the target point in the second image. In the identification step, the search for the target point in the second image may begin at said likely position, or in a defined target area around said likely position.

The invention has just been described with reference to a target point of a scene appearing in the first image.

Of course, the method according to the invention may comprise an iteration of the processing phase, in turn or simultaneously, for several target points of the first image. In this way, a depth data may be determined for several target points of a scene appearing in the first image.

In particular, the processing phase may be carried out for each point of the first image. In this case, each point in the first image is a target point.

Alternatively, the processing phase may be carried out for pre-selected target points within the first image. In this case, the method according to the invention may comprise a phase for selecting target points in the first image.

The selection of target points in the first image may be done using any technique/solution, or relationship.

According to some embodiments, the phase of selecting target points in the first image may comprise the following steps:
extracting a spatial gradient at each point of said first image, in particular by deriving said image, and even more particularly by Sobel filtering;
calculating a gradient norm for each point, in particular the Euclidean norm; and
selecting, as target points, the points whose gradient norm is greater than a predefined threshold.

In this way, the points in the first image for which the processing phase is carried out are the points of interest based on the norm of the spatial gradient. These points are generally the boundaries of the various objects in the scene, and provide a good indication of how the scene is evolving. In this way, the method according to the invention avoids processing all the points of the scene in the first image, but only those points of interest, thus optimizing processing of the first image in terms of time and computer resources.

The spatial gradient may be calculated on any of the stored parameters for each pixel. Alternatively, the spatial gradient may be calculated on a parameter which itself is deduced from at least one of the stored parameters for each pixel. For example, the spatial gradient may be calculated on brightness, the latter being able to correspond to a weighted sum of the R, G and B components for each pixel in an RGB image.

According to some embodiments, the method according to the invention may comprise, for at least one target point, storing the depth data of said target point, in association with said target point, in the first image and/or in the second image.

The depth data may be stored with the pixel data corresponding to said target point, in the first image and/or in the second image.

Additionally, according to an optional advantageous feature, the method according to the invention may comprise storing:
the speed data, and/or
the acceleration data,
   optionally calculated for the target point during the processing phase implemented for said target point, in the first image and/or in the second image, for example with the data of the pixel corresponding to said target point.

Of course, the method according to the invention may be implemented to determine depth information of a scene, at several instants in time, from at least two image streams of said scene taken by at least two cameras positioned at different positions, each image stream comprising at least one image of said scene taken for each of said several instants.

At least at one current instant, the method according to the invention may be implemented to determine a depth of a point for which no depth data has been determined at past instants. This allows new points in the scene to be taken into consideration.

Alternatively or additionally, at least at one current instant, the method according to the invention may be implemented to determine a depth of a target point of the scene for which a depth data has been determined at least at one past instant. Thus, at said current instant, the depth of this target point may be known at said current instant but also at least at one past instant, making it possible to track the evolution of the depth of this target point over time.

Additionally, advantageously, by knowing the depth of the same target point at different instants, it is possible to calculate:
the speed of said speed target point in the direction perpendicular to the image plane, for example in the reference frame linked to the scene;
and possibly the acceleration of said target point in said direction.
   The processing phase may further comprise a step for calculating such a speed, and/or a step for calculating such an acceleration, for at least one target point. The method according to the invention, or the processing phase, may further comprise storing this speed, and/or this acceleration, in the first image, and/or in the second image, in particular in the data of the pixel corresponding to said point in said image.

According to another aspect of the invention, an enhanced image of a scene, stored on a memory means, obtained by the method according to the invention, is offered.

The enhanced image according to the invention is a digital image, preferably raster.

The storage medium can be of any type, portable or not, such as a memory card, a USB key, a computer, a server, a telephone, a camera and so on.

According to another aspect of the invention, it is proposed to use enhanced image(s) according to the invention for at least one of the following applications:
detecting an object in a scene at a given instant,
tracking an object in a scene over time,
assistance with piloting, or for autonomous or semi-autonomous piloting, of a vehicle.

In fact, at least one depth data associated with a target point may be used to detect an object in this image because it is likely that points with the same depth, and optionally the same speed and/or acceleration, belong to the same object. It is therefore possible to discriminate and/or detect objects in an enhanced image according to the invention based on depth data, and optionally speed data and/or acceleration data.

Additionally, the depth data associated with a target point at several instants may be used to track this target point over time, and thus to track the object to which it belongs over time.

Furthermore, as mentioned above, the depth data of a target point at two different instants may be used to calculate at least the speed of this point in the depth direction, that is to say in the direction perpendicular to the image plane. This speed data may be used to estimate, or predict, the likely position of a target point, and therefore of the object to which it belongs, in the near future, and in particular at a subsequent instant, in said depth direction. This improves the tracking of an object in time and space. In addition, it may be used to assist the piloting of a vehicle or robot.

According to another aspect of the invention, a computer program is proposed comprising executable instructions, which, when they are executed by a computer, implement all the steps of the method according to the invention.

The computer program may be in any computer language, such as, for example, in machine language, in C, C++, JAVA, Python, etc.

According to another aspect of the invention, a device is proposed comprising means configured to implement all the steps of the method according to the invention.

The device according to the invention can be any type of apparatus such as a server, a computer, a tablet, a calculator, a processor, a computer chip, a camera, programmed to implement the method according to the invention.

For example, the device according to the invention may be provided with a computer program according to the invention.

In particular, the processing device may be integrated into, or may be, one of the first and second cameras, and more generally, one of the cameras used to image the scene and providing the processed image(s).

According to another aspect of the present invention, a system is proposed comprising:
at least two camera modules intended to image a scene from two different capture positions, and
a device comprising means configured to implement all the steps of the method according to the invention, or a device according to the invention.

Each camera module can comprise at least one lens and at least one image sensor, such as a CCD or CMOS sensor.

According to another aspect of the present invention, a vehicle fitted with at least one imaging system according to the invention is proposed.

According to some embodiments, the vehicle may be a land vehicle, such as a car, autonomous or not.

According to some embodiments, the vehicle may be a flying vehicle, such as a drone, an airplane or a helicopter, autonomous or not.

According to some embodiments, the vehicle may be a marine vehicle, such as boat or a submarine, autonomous or not.

According to yet another aspect of the present invention, a method for assisting the driving of a vehicle is proposed, comprising at least one iteration of the following steps:
determining, by the method according to the invention, a depth data or a distance data, associated with at least one target point, and in particular with an object to which said at least one target point belongs, of a scene imaged from said vehicle, and
generating at least one instruction relative to driving said vehicle based on said depth data and/or said distance data.

According to another aspect of the present invention, a user apparatus fitted with an imaging system according to the invention is proposed.

The user apparatus can be a camera, a smartphone, a tablet, a virtual reality headset, an augmented reality headset, etc.

According to another aspect of the present invention, a medical imaging apparatus fitted with an imaging system according to the invention is proposed.

The medical imaging apparatus may be an endoscope, in particular a disposable endoscope.

### DESCRIPTION OF THE FIGURES AND EMBODIMENTS

Other benefits and features shall become evident upon examining the detailed description of entirely non-limiting embodiments, and from the appended drawings wherein:

FIG. 1 is a schematic depiction of a non-limiting exemplary embodiment of a selection phase of target points in an image that may be implemented in the present invention;

FIG. 2 is a schematic depiction of a non-limiting exemplary embodiment of a speed calculating step that may be implemented in the present invention;

FIG. 3 is a schematic depiction of a non-limiting exemplary embodiment of a depth calculation that may be implemented in the present invention;

FIG. 4 is a schematic representation of a non-limiting exemplary embodiment of a method according to the present invention;

FIG. 5 is a schematic representation of a non-limiting exemplary embodiment of a method according to the invention applied to image streams;

FIG. 6 is a schematic representation of a non-limiting example embodiment of a device according to the invention;

FIG. 7 is a schematic depiction of a non-limiting exemplary embodiment of an imaging system according to the invention; and

FIG. 8 is a schematic representation of a non-limiting exemplary embodiment of a car according to the invention.

It is clearly understood that the embodiments that will be described hereafter are by no means limiting. In particular, it is possible to imagine variants of the invention that comprise only a selection of the features disclosed hereinafter in isolation from the other features disclosed, if this selection of features is sufficient to confer a technical benefit or to differentiate the invention with respect to the prior art. This selection comprises at least one preferably functional feature which is free of structural details, or only has a portion of the structural details if this portion alone is sufficient to confer a technical benefit or to differentiate the invention with respect to the prior art.

In particular, all of the described variants and embodiments may be combined with each other if there is no technical obstacle to this combination.

In the figures and in the remainder of the description, the same reference has been used for the features that are common to several figures.

FIG. 1 is a schematic depiction of a non-limiting exemplary embodiment of a selection phase of target points in an image that may be implemented in the present invention.

The selection phase 100 of FIG. 1 may be used to select target points, in a first image of a scene taken by a first camera arranged at a first capture position, for which a depth is determined by the method according to the invention using a second image of said scene taken by a second camera, arranged at a second capture position.

The purpose of the selection phase 100 shown in FIG. 1 is to select the points of interest in the first image. The points of interest are generally the boundaries of the various objects in the scene, and provide a good indication of how the scene is evolving. Thus, the aim of the selection phase 100 is to avoid processing all the points of the scene in the first image, in the rest of the method, thus optimizing processing of the first image in terms of time and computer resources.

The scene point(s) in the image can be selected according to any logic, or relationship, during the selection phase 100.

In the following, the first image of the scene is referred to as IM1.

According to some embodiments, the selection phase 100 comprises a step 102 of extracting a spatial gradient at each point of the first image IM1 by Sobel filtering, for example in relation to brightness.

Then, in a step 104, for each point of the first image IM1, a norm, in particular a Euclidean norm, is calculated for each gradient calculated in step 102.

Then, in a step 106, each point whose gradient norm is greater than a predefined selection threshold is selected as a target point.

The selection threshold may be determined by test. Alternatively, the selection threshold may be calculated based on the Euclidean norms calculated for all points in the first image. For example, the selection threshold may correspond to an average of the Euclidean norms calculated in step 104.

In this way, the points in the first image for which the processing phase will be carried out are those of interest based on the norm of the spatial gradient. As mentioned above, these points are generally the boundaries of the various objects in the scene, and provide a good indication of how the scene is evolving.

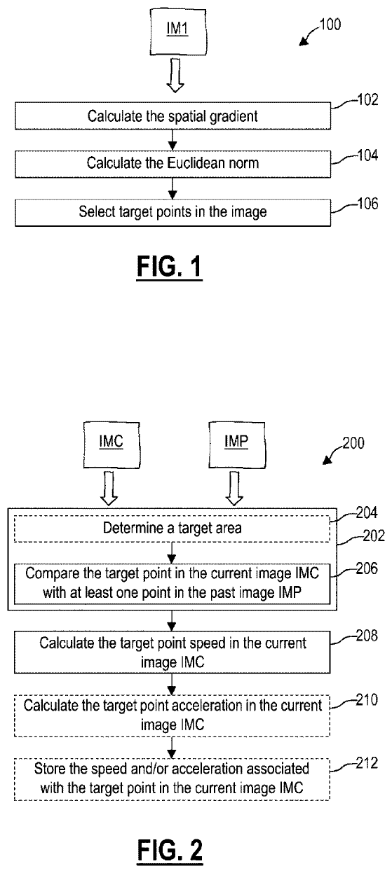

FIG. 2 is a schematic depiction of a non-limiting exemplary embodiment of a speed calculating step that can be implemented in the present invention.

Step 200 of FIG. 2 may be used to calculate, for a target point of a scene appearing in an image, called current image, noted IMC, a speed associated with said target point in the image plane, noted plane UV in the reference frame associated with the image sensor. The current image IMC is captured by a camera at an instant, known as the current instant.

The speed calculation uses an image, known as the past image, denoted IMP, captured by the same camera at a past instant with respect to the current instant. Preferentially, the camera is stationary. If the camera is mobile between the past and current instants, then its displacement is taken into account in the speed calculation.

The calculation step 200 comprises a step 202 to identify the target point of the current image, in the past image. Identification is performed by comparing the pixel corresponding to the target point in the current image with at least one pixel in the past image. The comparison relates to at least one of the following data:
color data,
texture data,
brightness data,
hue data,
saturation data,
RGB data,
at least one parameter calculated from at least one of these data,
etc.

The target point may be compared with all the points in the past image, to identify it in the past image.

Alternatively, the identification step 202 may comprise an optional step 204 to determine a target area in the past image and wherein the target point may be located. The target area may be identified from speed data associated with points in said past image, when such speed data are known. In fact, by knowing the speeds of at least some of the points in the past image, it is possible to determine which of these points could potentially be in the current image at the location of the target point in said current image. In this way, it is possible to determine a likely position of the target point in the past image. A target area, for example of a predetermined size/area, may be defined around said likely position. The search for the target point in the past image may begin at said likely position, or in said target area.

In a step 206, the target point is compared with one or more points in the past image:
starting at an arbitrary position, if optional step 204 is not performed, or
starting with the likely position, or with the target area, if optional step 204 is performed.

If the comparison fails to identify the target point, for example because there are no points in the past image that are identical or sufficiently similar to the target point, step 200 is terminated.

Otherwise, step 200 is continued.

In a step 208, the speed, VCᵤᵥ, of the target point in the image plane, expressed in the reference frame UV associated with the image sensor, is calculated, for example using the following relationship:

$${VC}_{uv} = ( {PPC}_{uv} - {PPP}_{uv} ) / ( {I}_{c} - {I}_{p} )$$

where
PPCᵤᵥ the position of the target point in the current image, expressed in the reference frame UV associated with the image sensor;
PPPᵤᵥ the position of the target point in the past image, expressed in the reference frame UV associated with the image sensor;
I_{c} the current instant, and
Iₚ the past instant.

When the speed, noted VPᵤᵥ, of the target point in the image plane UV is known for the past image IMP, then step 200 can comprise an optional step 210 for calculating the acceleration, noted ACᵤᵥ, of the target point in the image plane UV, expressed in the reference frame linked to the image sensor, for the current image IMC, for example using the following relationship:

$$A {C}_{uv} = ( {VC}_{uv} - {VP}_{uv} ) / ( {I}_{c} - {I}_{p} )$$

In an optional step 212, the speed VCᵤᵥ and/or acceleration ACᵤᵥ associated with the target point in the current image may be stored, for example directly in the current image, for example in the data of the pixel corresponding to said target point in the current image IMC.

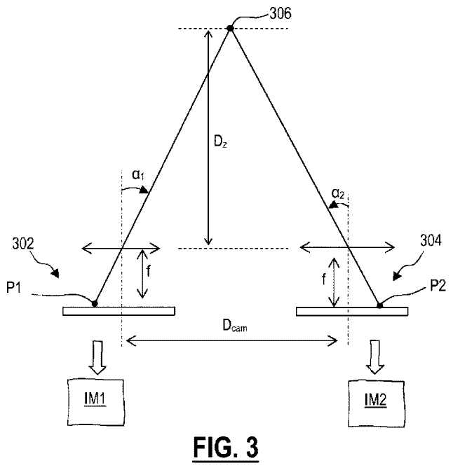

FIG. 3 is a schematic depiction of a non-limiting exemplary embodiment of depth calculating step of a point of a scene appearing in both images of this scene, which can be implemented in the present invention.

FIG. 3 shows a configuration wherein a scene is imaged with a first camera 302 providing a first image IM1 of the scene and a second camera 304 providing a second image IM2 of the scene. Each of the cameras 302 and 304 is shown very schematically.

The respective positions of the cameras 302 and 304 are known, so that the distance, denoted D_{cam}, between the camera positions is known at the time of capture of the images IM1 and IM2.

A point 306 in a scene imaged by the camera 302 is located at a position PI={u1,v1}, expressed in the reference frame UV associated with the image sensor, on the sensor of camera 302: point 306 therefore corresponds to the pixel located at position P1 in image IM1. When the scene is imaged by the camera 304, said point 306 of the scene is at a position P2={u2, v2} on the sensor of the camera 304: point 306 therefore corresponds to the pixel at position P2 in image IM2. Note d=P1−P2.

Assuming that the focal lengths f of the cameras 302 and 304 are the same, and making the approximation that:
the respective sensors of the cameras 302 and 304 are positioned in the same plane, and
the focal length f is very small compared with the distance D_{z} between each of the cameras 302-304 and point 306, in the direction Z perpendicular to the image sensor plane;
   said distance D_{z} can be calculated according to the following relationship:

$${D}_{z} = {D}_{cam} \cdot f / d$$

Since the focal length f is very small compared to D_{z}, then D_{z} corresponds to the distance between the plane of each sensor and the point 306 in the scene, and therefore to the depth of said point in each of the images IM1 and IM2.

The technique described with reference to FIG. 3 is by no means limitative. It can be used to calculate the depth associated with a target point in a scene using a first image and a second image of said scene.

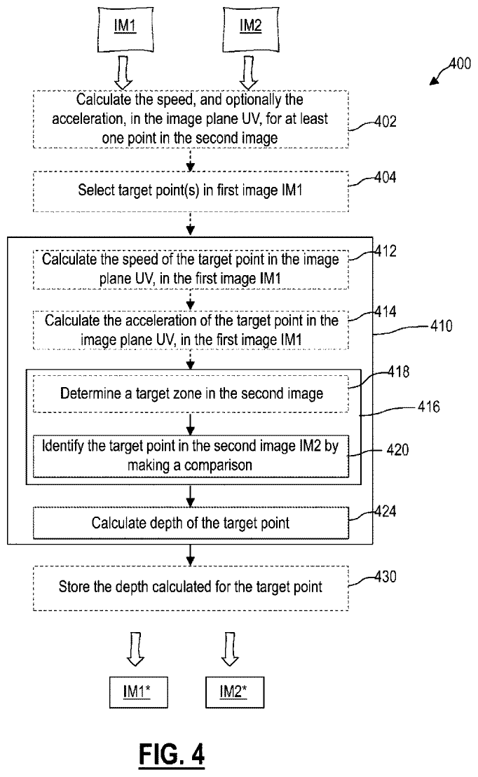

FIG. 4 is a schematic representation of a non-limiting exemplary embodiment of a method according to the invention.

The method 400 of FIG. 4 may be used to determine depth information for at least one point, called a target point, of a scene appearing in a first image, IM1, of said scene captured by a first camera from a first capture position, using a second image, IM2, of said scene taken by a second camera from a second capture position, different from said first capture position.

The images IM1 and IM2 may be captured at different instants, but close together so that displacements of objects in the scene are negligible between said different instants. Preferentially, the images IM1 and IM2 are captured at the same instant, referred to hereinafter as the current instant.

The method 400 may optionally comprise a step 402 for calculating a speed, and optionally an acceleration, in the image plane UV, associated with at least one point, and in particular several points, of the scene appearing in the second image IM2, expressed in the reference frame associated with the image sensor. For at least one point in the second image IM2, the speed, and possibly the acceleration, in the image plane UV may be calculated by any technique. In a non-limiting example embodiment, step 402 may be step 200 of FIG. 2. In this case, for at least one point in the second image IM2, the speed, and possibly the acceleration, is calculated using a past image captured by the second camera at a past instant with respect to the current instant of capture of the second image.

Alternatively, the speed, and possibly acceleration, in the image plane UV associated with at least one point of the second image IM2 may be previously calculated, or measured, and provided in association with said second image, for example stored in said second image, in particular in the data of the pixel corresponding to said point.

Optionally, but particularly advantageously, the method 400 may comprise a phase 404 for selecting, in the first image IM1, one or more target points for which depth information is determined by the method according to the invention. For example, the phase 404 may be the phase 100 of FIG. 1.

Alternatively, depth information may be determined for each of the points in the first image IM1.

The method 400 comprises a processing phase 410 for calculating, for a target point of the scene appearing in the first image IM1, depth information for said target point in the first image IM1, using the second image IM2.

The phase 410 is carried out individually for each target point. When several target points are to be processed, a processing phase 410 is carried out for each of said target points in turn, or simultaneously.

The processing phase 410 may comprise an optional step 412 to determine a speed VCᵤᵥ of the target point in the image plane UV, in the first image IM1. The VCᵤᵥ speed may be determined using any known technique. In a non-limiting example embodiment, the speed VCᵤᵥ may be determined by/according to step 200 of FIG. 2. In this case, the speed of said target point in the image plane UV is calculated using a past image captured by the first camera at a past instant, relative to the current instant of capturing the first image.

Alternatively, the speed VCᵤᵥ of the target point in the image plane UV may be calculated or measured beforehand. In this case, said speed VCᵤᵥ may be provided in association with said first image, for example stored in said first image, in particular in the data of the pixel corresponding to said target point in the first image.

The processing phase 410 may comprise an optional step 414 to determine acceleration, denoted ACᵤᵥ, of the target point in the image plane UV in the first image IM1. The acceleration ACᵤᵥ may be determined using any known technique. In a non-limiting example embodiment, the acceleration ACᵤᵥ may be determined as described above with reference to step 210 of FIG. 2.

Alternatively, the acceleration speed ACᵤᵥ of the target point in the image plane UV may be previously calculated, or measured. In this case, said acceleration ACᵤᵥ may be provided in association with said first image, for example stored in said first image, in particular in the data of the pixel corresponding to said target point in the first image.

In some embodiments, optional steps 412 and 414 can be combined into a single step, so that the same step calculates both the speed and acceleration of the target point in the first image. Such a step may be identical to step 200 of FIG. 2.

The processing phase 410 then comprises a step 416 to identify the target point in the second image.

The identification step 416 may comprise an optional step 418 to identify a target area in the second image IM2, wherein the target point may be located. This identification can be carried out based on:
a speed associated with the target point at an instant preceding the current instant, for example in a past image taken by the first camera or in a past image taken by the second camera; and
a position of said target point in the first image, and/or in a past image captured by the first camera at a past instant before the current instant and/or in an image captured by the second camera at a past instant before the current instant.

Indeed, by knowing the position of the target point, it is possible to find it in a past image taken by the first camera, at a past instant. If, moreover, this target point has already been identified in a past image taken by the second camera at said past instant, for example during a previous iteration of the method. It is further possible that the speed of the target point has been determined in the past image taken by the first camera, or in the past image taken by the second camera, for example during a previous iteration of the method according to the invention. At least one of these data can be used to estimate a likely position of the target point in the second image.

A target area of a predetermined size can be defined around said likely position thus determined.

The identification step 416 comprises a step 420, in which the target point is searched for in the second image IM2. This search is carried out by comparing the target point with at least one point in the second image.

According to the invention, the comparison comprises a comparison of the speed VCᵤᵥ of the target point in the first image with the speed VCᵤᵥ of the point in the second image IM2.

Optionally, the comparison may comprise a comparison of the acceleration ACᵤᵥ of the target point in the first image with that ACᵤᵥ of the point in the second image IM2.

Optionally, but preferably, the comparison may comprise a comparison of the pixel corresponding to the target point in the first image with the pixel associated with the point in the second image compared with said target point, said comparison relating to at least one of the following data:
color data,
texture data,
brightness data,
hue data,
saturation data,
RGB data,
a data deduced from these data,
etc.

If the search performed in step 420 does not identify any point in the second image IM2 that is identical to, or sufficiently close to, the target point in the first image IM1, then the search has failed to identify the target point in the second image IM2. The processing phase 410 for this target point is then stopped.

When the search performed in step 420 identifies a point in the second image that is identical to, or sufficiently close to, the target point in the first image, the search can be stopped and the target point is identified in the second image IM2.

When optional step 418 is carried out, the search for the target point in the second image IM2, at step 420, may begin with the likely position, or position within the target area, identified at said optional step 418.

When optional step 418 is not performed, the search for the target point in the second image IM2, at step 420, may start at a random position, or the same position as the target point has in the first image IM1, etc.

At the end of identification step 416, and when the target point has been identified in the second image IM2, the position of said target point is known:
in the first image IM1, expressed in a reference frame associated with the image sensor of the first image IM1, and
in the second image IM2, expressed in a reference frame associated with the image sensor of the second image IM2

The processing phase 410 then comprises a step 424 for calculating the depth associated with the target point in the first image IM1, based on the position of the target point in the first image IM1 and the position of the target point in the second image IM2.

This depth calculation can be carried out by a conventional calculation technique, in particular by triangulation, using:
the position of the target point in the first image IM1,
the position of the target point in the second image IM2,
the distance between the first camera and the second camera when taking the first image IM1 and the second image IM2, and
the focal length of said cameras.

In particular, the depth can be calculated using the technique described with reference to FIG. 3.

When the depth associated with the target point is calculated for the target point, the processing phase 410 may be terminated for this target point. A new iteration of the processing phase 410 may be performed for another target point in the first image IM1. And so on.

The method 400 may comprise an optional step 430 of storing, for at least one target point in the first image IM1:
the depth data calculated in step 424 for said target point,
and optionally the speed data and/or acceleration data, calculated in optional step 412 and/or optional step 414.
   This, or these data, may be stored in particular with the pixel data corresponding to the target point. Thus, step 430 may provide a first enhanced image, denoted IM1*, with said data for one or more target points in said image.

Optional step 430 can also store, in the second image IM2 for at least one target point, at least one of the following data:
depth data calculated in step 424 for said target point,
and optionally the speed data and/or acceleration data calculated in optional step 412 and/or 414 for said target point.
   This, or these data, may be stored in particular with the data of the pixel corresponding to said target point in the second image.

Optional step 430 may also store, in the second image IM2 for at least one point of the second image IM2, at least one of the following data:
speed data, and/or
acceleration data;
   calculated in optional step 402 for said point of the second image IM2. This, or these data, may be stored in particular with the data of the pixel corresponding to said point in the second image. Thus, step 430 may provide a second enhanced image, denoted IM2*, with said data.

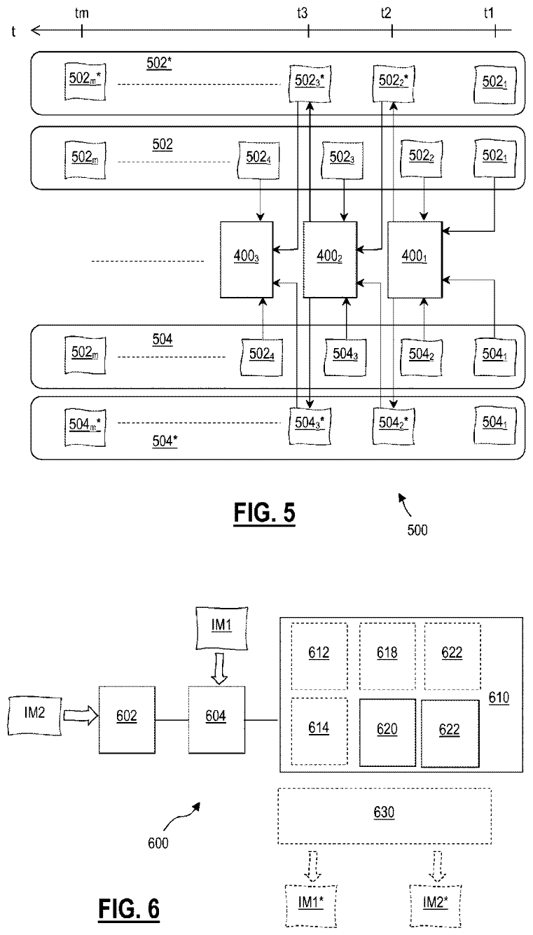

FIG. 5 is a schematic representation of a non-limiting exemplary embodiment of determining depth information with image streams.

In other words, FIG. 5 shows an example of the application of a method, and in particular the method 400 of FIG. 4, for determining depth information from two image streams 502 and 504, and in particular two videos, provided by two separate cameras for the same scene.

Image stream 502 comprises an image 502₁ captured at an instant t1, an image 502₂ captured at an instant t2 following t1, an image 502₃ captured at an instant t3 following instant t2, and so on up to an image 502ₘ captured at an instant tm.

The image stream 504 comprises an image 504₁ captured at instant t1, an image 504₂ captured at instant t2 following t1, an image 504₃ captured at instant t3 following instant t2, and so on up to an image 504ₘ captured at an instant tm.

In the example shown in FIG. 5, the image 502₁ is not processed by the method according to the invention. Likewise, the image 504₁ is not processed by the method according to the invention.

A first iteration of the method 400, noted 400₁, is carried out considering:
instant t2 as the current instant and instant t1 as the past instant;
the image 502₂ as the first image, and the image 502₁ as the past image relative to the first image 502₂; and
the image 504₂ as a second image, and the image 504₁ as a past image relative to the first image 504₂.
   This first iteration 400₁ of the method 400 provides depth data, each associated with a target point of the scene appearing in the first image 502₂, and in the second image 504₂. Optionally, the depth data, and possibly speed data, associated with the target points are stored in a first enhanced image denoted 502₂*, and/or a second enhanced image denoted 504₂*.

A second iteration 400₂ of the method 400 is performed considering:
instant t3 the current instant and instant t2 as the past instant;
the image 502₃ as the first image, and the image 502₂ or preferably the enhanced image 502₂* as the past image relative to the first image 502₃; and
the image 504₃ as a second image, and the image 504₂ or preferably the enhanced image 504₂* as a past image relative to the second image 504₃. This second iteration 400₂ of the method 400 provides depth data, each associated with a target point of the scene appearing in the first image 502₃, and in the second image 504₃. Optionally, the depth data, and possibly speed data and/or acceleration data, associated with the target points may be stored in a first enhanced image denoted 502₃*, and/or in a second enhanced image denoted 504₃*.

The method 400 may thus be repeated until, potentially, the remaining images of the streams 502 and 504 have been processed.

Optionally, the images 502₁, 502₂*-502ₘ* may be stored as the first enhanced stream 502*. The images 504₁, 504₂*-504ₘ* may be stored as a second enhanced stream 504*.

Each enhanced image obtained by the method according to the invention, that is to say the image IM1*, or IM2*, or each of images 502₂*-502ₘ* or each of images 504₂*-504ₘ*, may be used to identify objects in said image using the depth data calculated for said image.

In addition, the images 502₂*-502ₘ* from the stream 502*, or the images 504₂*-504ₘ* from the stream 504*, may be used to track objects in these images using the calculated depth data.

Furthermore, in the image stream 502*, respectively in the image stream 504*, the variation over time of the depth of a target point may be used to predict the depth of said target point, and therefore of an object to which this target point belongs, at a future instant. This prediction may be used to generate a command or setpoint, for example within a vehicle. Such a command or instruction may be a driving instruction, an emergency braking or object avoidance maneuver, or a trajectory modification, for example.

FIG. 6 is a schematic representation of a non-limiting embodiment of a device according to the present invention.

The device 600 is configured to implement the method according to the invention, and in particular the method 400 of FIG. 4, for determining depth information of at least one target point of a scene appearing in a first image of the scene captured by a first camera, using a second image of said scene captured by a second camera.

The device 600 may optionally comprise a module 602 for processing the second image IM2 and calculating the speed, and optionally an acceleration, in the image plane XY, of at least one point of the scene appearing in said second image. In particular, the module 602 may be configured to implement step 402 of the method 100 of FIG. 1.

The device 600 may optionally comprise a module 604 for pre-processing the first image IM1, with a view to selecting target points of interest in said first image IM1. In particular, the module 604 may be configured to implement step 404 of the method 400 of FIG. 4.

The device 600 comprises a module 610 for processing at least one target point in the first image to determine a depth data associated with said target point. The processing module 610 may be configured to implement the processing phase of the method according to the invention and in particular phase 410 of the method 400 of FIG. 4.

The module 610 may optionally comprise a module 612 for determining a speed associated with the target point in the image plane. In particular, the module 612 may be configured to implement step 412 of the method 400 of FIG. 1.

The module 610 may optionally comprise a module 614 for determining an acceleration associated with the target point in the image plane. In particular, the module 614 may be configured to implement step 414 of the method 400 of FIG. 1.

The module 610 may optionally comprise a module 618 for determining a target area in the second image IM2. In particular, the module 618 may be configured to implement step 418 of the method 400 of FIG. 4.

The module 610 comprises a module 620 for identifying the target point in the second image IM2. In particular, the module 620 may be configured to implement step 420 of the method 400 of FIG. 4.

The processing module 610 comprises a module 622 for calculating the depth of the target point in the image IM1. In particular, the module 622 may be configured to implement step 424 of the method 400 of FIG. 4.

The device 600 can optionally comprise an enhancement module 630 for adding, in the first image IM1, and/or in the second image IM2, a depth data and possibly a speed data and/or an acceleration data, associated with at least one point of the scene appearing in said image. In particular, the module 630 may be configured to implement step 430 of the method 400 of FIG. 4.

At least one of the modules 602-604, 610-614, 618-622 and 630 may be an individual module, independent of the other modules. Alternatively, at least two of these modules may be integrated into the same module. In particular, all the modules of the device 600 may be integrated into the same module.

At least one of the modules 602-604, 610-614, 618-622 and 630 may be a hardware module, such as a processor, chip, graphics card, calculator, computer, server, etc.

Alternatively, at least one of the modules 602-604, 610-612, 618-622 and 630 may be a software module executed by at least one computing means.

According to yet another alternative, at least one of the modules 602-604, 610-614, 618-622 and 630 may be a combination of at least one hardware module and at least one software module.

The configuration of one or each of the modules 602-604, 610-614, 618-622 and 630 may be a software configuration, such as an application or computer program loaded in said module, and/or a hardware configuration, such as a specific hardware architecture.

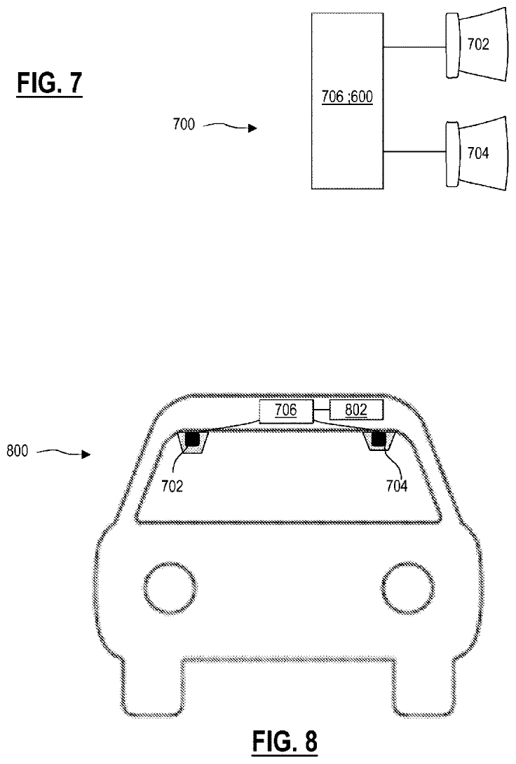

FIG. 7 is a schematic depiction of a non-limiting example embodiment of an imaging system according to the present invention.

The system 700 may be configured to implement a method according to the invention, and in particular the method 400 of FIG. 4.

The system 700 comprises a first camera module 702 comprising at least one lens and at least one image sensor, for example a CCD or CMOS sensor. The first camera module 702 captures a first image, or a first stream of images, of a scene.

The system 700 comprises a second camera module 704 comprising at least one lens and at least one image sensor, for example a CCD or CMOS sensor. The second camera module 704 captures a second image, or a second stream of images, of the scene.

The imaging system 700 further comprises a processing unit 706, which may for example be the device 600 of FIG. 6, for determining depth information for at least one target point of a scene appearing in the images captured by the modules 702-704.

At least one of the camera modules 702-704 and the processing unit 706 may be incorporated into a single unit. Alternatively, at least one camera module 702-704 and the processing unit 706 may not be incorporated into a single unit and may be independent of one another. In this case, said at least one camera module and the processing unit are in direct or indirect, wired or wireless, communication.

FIG. 8 is a schematic depiction of a non-limiting example embodiment of a vehicle according to the present invention.

The vehicle 800 shown in FIG. 8 may be any type of land vehicle, such as a car, truck, etc.

Vehicle 800 may be a vehicle, partially or fully autonomous or not.

FIG. 8 shows a front view of the vehicle 800.

The vehicle 800 is fitted with an imaging system according to the invention, and in particular with the system 700 of FIG. 7. In general, the vehicle 800 may be fitted with:
at least two camera modules, for example the camera modules 702 and 704;
at least one processing unit 706.

Of course, the camera modules 702-704 and the processing unit 706 may be positioned at any suitable location in the vehicle. In the example shown, the camera modules 702-704 are located at the front of the vehicle and image the scene in front of the vehicle 800.

The processing unit 706 may be a single, independent unit. Alternatively, the processing unit 706 may be integrated into a calculator, or management unit, (not shown) of the vehicle 800.

The vehicle 800 may comprise a driving assistance unit 802, which receives enhanced images from the processing unit 706, or depth values, or any other property determined from the depth values, and provides driving instructions either to the vehicle driver, or directly to vehicle members.

Of course the invention is not limited to the examples disclosed above.

1. A method for determining depth information of a scene in a first image of said scene captured by a first camera positioned at a first capture position, said method comprising, for a target point of said scene in said first image, a processing phase comprising:
identifying said target point in a second image captured by a second camera positioned at a second capture position different from said first position, and
calculating a depth associated with said target point based on a position of said target point on each of said first and second images;
wherein identifying said target point comprises comparing a speed data of said target point in said first image with a speed data of at least one point in said second image, said speed data being previously calculated.

2. The method according to claim 1, wherein the speed data associated with a point of an image is calculated from said image and from at least one image, called past image, captured by the same camera at a past instant preceding the instant, called current instant, at which said image is captured.

3. The method according to claim 2, wherein calculating the speed data of a point in an image comprises:
identifying said point in the past image;
calculating a distance separating the positions of said point in said image and in the past image; and
calculating a speed data based on said distance and a duration of time separating the current and past instants.

4. The method according to claim 1 wherein identifying the target point in the second image comprises comparing an acceleration data associated with said target point in said first image with an acceleration data of at least one point in said second image, said acceleration data being previously calculated.

5. The method according to claim 1, wherein identifying the target point in the second image further comprises a comparison of a pixel corresponding to said target point in the first image with at least one pixel in the second image, said comparison relating to at least one or more of the following data:
color data,
texture data,
brightness data,
hue data,
saturation data,
RGB data, and
a data deduced from these data.

6. The method according to claim 1, wherein identifying the target point in the second image comprises a selection of a target area wherein said target point may be located in the second image, said selection being made based on:
a speed in the image plane associated with said target point at an instant prior to the current instant; and
a position of said target point in the first image, and/or in an image captured by the first camera at an instant before the current instant and/or in an image captured by the second camera at an instant before the current instant.

7. The method according to claim 1, wherein the method comprises an iteration of the processing phase for several target points of the first image.

8. The method according to claim 1, wherein the method comprises a phase of selecting, in the first image, at least one target point, wherein said selecting, in the first image, at least one target point comprises:
extracting a spatial gradient at each point of said first image;
calculating a gradient norm for each point; and
preserving, as target points, the points whose gradient norm is greater than a predefined threshold.

9. The method according to claim 1, wherein the method is implemented to determine a depth for at least one point of a scene, at several instants in time, from at least two image streams of said scene taken by two cameras positioned at different positions, each image stream comprising at least one image of said scene taken for each of said several instants.

10. The method according to claim 1, wherein the method further comprises, for at least one target point, storing the depth data of said target point, in association with said target point, in the first image and/or in the second image.

11. An enhanced image of a scene, stored on a memory means, obtained by the method according to claim 10.

12. A use of enhanced image(s) of a scene according to claim 11 for at least one of the following applications:
detecting an object in a scene at a given instant,
tracking an object in a scene over time, and
assistance with piloting, or for autonomous or semi-autonomous piloting of a vehicle.

13. A computer program comprising executable instructions which, when the executable instructions are executed by a computer, implement all the steps of the method according to claim 1.

14. A device comprising means configured to implement all the steps of the method according to claim 1.

15. A system comprising:
at least two camera modules intended to image a scene from two different capture positions, and
a device comprising means configured to implement all the steps of the method according to claim 1.

16. A user apparatus comprising an imaging system according to claim 15.

17. A vehicle comprising an imaging system according to claim 15.

18. The method of claim 8, wherein extracting the spatial gradient at each point of said first image comprises deriving said image.

19. The method of claim 18, wherein deriving said image comprises Sobel filtering.

20. The method of claim 8, wherein calculating the gradient norm for each point comprises the Euclidean norm.
